(19) United States
(12) Patent Application Publication
(10) Pub. No.: US 2024/0428076 A1
(43) Pub. Date: Dec. 26, 2024

(54) TORCHDEQ: A LIBRARY FOR DEEP EQUILIBRIUM MODELS

(71) Applicant: Robert Bosch GmbH, Stuttgart (DE)

(72) Inventors: Zhengyang Geng, Pittsburgh, PA (US); Jeremy Kolter, Pittsburgh, PA (US); Ivan Batalov, Pittsburgh, PA (US); Joao Semedo, Pittsburgh, PA (US)

(21) Appl. No.: 18/340,574

(22) Filed: Jun. 23, 2023

(51) Int. Cl. G06N 3/084

(52) U.S. Cl. CPC G06N 3/084

(57) ABSTRACT

Methods and systems are disclosed that allows users to define, train, and deploy deep equilibrium models. Decoupled and structured interfaces allow users to easily customize deep equilibrium models. Disclosed systems support a number of different forward and backward solvers, normalization, and regularization approaches.

### TECHNICAL FIELD

The present disclosure relates generally to the field of artificial intelligence. More specifically, disclosed embodiments relate to the design, training, and use of machine-learning models, including neural networks.

### BACKGROUND

Deep Equilibrium Models (“DEQs”) are a recently-developed class of implicit neural network. DEQs have an emerging community. DEQs are receiving growing attention theory-wise. Stability and acceleration are active research topics in the DEQ community. DEQs show appealing generalization performance, interpretability, and robustness over semantic segmentation, optical flow, detection, inverse problem, meta learning, object-centric learning, set prediction, control, spiking neural networks, machine translation, normalizing flow, and graph learning.

Scientific software assists deep learning to grow more complex, modular, and large-scale. From fundamental deep learning libraries like PyTorch, Tensorflow, and JAX to comprehensive model zoos like huggingface, and domain-specific libraries like fairseq for language models, and timm for vision backbones, contributions of open-source software are reckoned.

### SUMMARY

Recently, there have been many deep learning libraries for neural dynamics like differentiable optimization or differential equations, e.g., theseus, torchopt, torchdiffeq, torchdyn, betty, and pypose. But none of them is particularly designed for DEQs and verified to scale up to modern DEQs with good stability. Moreover, none of them is particularly designed for DEQs and verified for hosting a model zoo for implicit models. Disclosed embodiments step toward this and widely support state-of-the-art deep equilibrium models.

Some disclosed embodiments include methods comprising: receiving user input identifying a deep equilibrium model and a training dataset; and training the deep equilibrium model on the training dataset, wherein the training includes performing a normalization method according to:

$$W = W ∘ min ( t , f ) = W ∘ min ( t , \frac{g}{N ( W )} ) ,$$

where ƒ is the deep equilibrium model, W is a weight matrix, g is a learnable scaling factor, ∘ is a row-wise multiplication, t is a threshold for clipping the scaling factor g, and N is a computation of a norm for the weight matrix W. Some disclosed embodiments include methods comprising: receiving user input identifying a deep equilibrium model and identifying a training dataset; and training the deep equilibrium model on the training dataset, wherein the training includes performing forward and backward solvers to conduct forward and backward passes through the deep equilibrium model, and wherein the forward and backward solvers are identified in the user input. Some disclosed embodiments include systems comprising: one or more processors; and non-transitory memory including processor-executable instructions that, when executed by the one or more processors, causes the system to perform operations including: receiving user input identifying a deep equilibrium model and identifying a training dataset; and training the deep equilibrium model on the training dataset, wherein the training includes: performing forward and backward solvers to conduct forward and backward passes through the deep equilibrium model, wherein the forward and backward solvers are identified in the user input; and performing one or more of the following: automatic normalization of weight tensors; Jacobian regularization; and fixed point correction.

### BRIEF DESCRIPTION OF THE DRAWINGS

FIG. 1 illustrates example code in accordance with disclosed embodiments.

FIG. 2 illustrates a flowchart of an example method for training a DEQ in accordance with disclosed embodiments.

FIG. 3 illustrates a block diagram of system in accordance with disclosed embodiments.

FIG. 4 illustrates an example embodiment of a general computer system in accordance with the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Training and applying DEQs is currently done in an ad-hoc fashion, with various techniques spread across the literature. The present disclosure systematically revisits DEQs and example embodiments include a PyTorch-based library, referred to herein as TorchDEQ, that allows users to define, train, and infer using DEQs over multiple domains with minimal code and best practices. Disclosed embodiments, which may be referred to herein as a “DEQ zoo”, support six published implicit models across different domains. Disclosed embodiments include a joint framework that incorporates the best practice across all models and was used to substantially improve the performance, training stability, and efficiency of DEQs on ten datasets across all six models in the DEQ Zoo.

### 1.0 Introduction

Unlike traditional feedforward models, which compute their output using a fixed-size computational graph, DEQs define their output as a fixed point of nonlinear systems, i.e.,

z*=ƒ_{θ}(z*,x).

where x denotes the input to the network and z* is its output. There are several notable benefits to this formulation: DEQs can be interpreted as “infinite depth” limits of the fixed point iteration z^{l+1}=ƒ_{θ}(z¹, x), thus offering rich representations using relatively few parameters; they require only specifying a “single” layer in their architectural design; they can be trained with substantially less memory, as only the final fixed point z* needs to be stored for backpropagation; they (often) recover path-independent solutions where the final output z* is independent of its initialization; and finally, they intuitively allow for a separation between the “definition” of a network and the “solver” that computes the fixed point, a separation that mirrors many settings in e.g., differential equation solvers or optimizers.

Unfortunately, DEQs in practice are often difficult to train and challenging to deploy. Training DEQs can often result in unstable systems, and methods for addressing these stability challenges are spread across different papers in the literature; similarly, backpropagation in these networks can be done in many different manners, i.e., through unrolling, through implicit differentiation, or via inexact “phantom” gradients; finally, the choice of architecture and equilibrium solver must often be made anew for different applications. These challenges, we believe, have substantially limited the impact of DEQs broadly within deep learning.

To this end, we develop a modular library in this paper, which may be referred to herein as TorchDEQ. TorchDEQ is a carefully designed, fully featured, and PyTorch-based library for building and deploying DEQs. It provides decoupled and structured interfaces that allows users to customize their own general-purpose DEQs, for arbitrary tasks, through a minimal amount of code. The library supports a number of different forward solvers, backward pass methods, normalization, and regularization approaches, implementing the best practices of the entire field.

Disclosed embodiments of the modular library (i.e., TorchDEQ) may include a model zoo for DEQs, which may be referred to herein as a “DEQ Zoo”. Disclosed embodiments have implemented six published implicit models via TorchDEQ, including DEQ Transformer, Multiscale Deep Equilibrium Models (“MDEQ”), Implicit Graph Neural Networks (“IGNN”), Deep Equilibrium Optical Flow Estimator (“DEQ-Flow”), Implicit Layers for Implicit Representations (“DEQ-INR”), and Deep Equilibrium Approaches to Diffusion Models (DEQ-DDIM”). Uniformly better results were obtained, in terms of performance, stability, and efficiency, for all these models over what was reported in the original papers and the released code.

### 2.0 TorchDEQ

Embodiments of TorchDEQ and example supported features in TorchDEQ are disclosed below in further detail. Example embodiments disclosed below may include descriptions of DEQs; an example interface of TorchDEQ, including example code; and a computational graph design of TorchDEQ, which may highlight different approaches for approximating backward passes as well as other DEQ strategies.

### 2.1 DEQs

Given an input data pair (x, y) and a loss function L, DEQ is an implicit mapping from an input injection u(x) to the fixed points z* of a neural network ƒ_{θ}. The training objective is as follows,

$$arg {min}_{θ} L ( y , y ( {z}^{*} ) ) \qquad ( 1 )$$

$${z}^{*} = {f}_{θ} ( {z}^{*} , u ( x ) )$$

where u(x) is an injection function, and y (z*) is a decoder to produce the model prediction. In the forward pass, the “infinite-depth” equilibrium representation z* can be solved by a black-box solver, e.g., fixed point iteration, Anderson acceleration, or Broyden's method. Despite these “infinite layers”, differentiating through this fixed-point system has an elegant solution.

Theorem 2.1. By the Implicit Function Theorem (“IFT”), under mild conditions, the gradient of DEQ can be expressed as

$$\frac{\partial L}{\partial θ} = \frac{\partial L}{\partial {z}^{*}} {( I - \frac{\partial {f}_{θ}}{\partial z} * )}^{- 1} \frac{\partial {f}_{θ} ( {z}^{*} , x )}{\partial θ} . \qquad ( 2 )$$

$$where \frac{\partial L}{\partial {z}^{*}} {( I - \frac{\partial {f}_{θ}}{\partial {z}^{*}} )}^{- 1}$$

is a gradient g^{T}. This solution entails solving another “mirror” linear fixed-point system in the backward pass to obtain gradient g^{T}.

$${g}^{T} = {g}^{T} \frac{\partial {f}_{θ}}{\partial {z}^{*}} + \frac{\partial L}{\partial {z}^{*}} . \qquad ( 3 )$$

This backward equilibrium system is itself a (linear) fixed-point operation, and thus, can be using similar (or even simpler) techniques as the forward pass. Thus, we can differentiate through DEQ using O(1) memory complexity (i.e., independent of the number of solver steps) without storing function ƒ_{θ} activations or the computational graph of the black-box solver.

### 2.2 Sample Code and Interface

There is a commonality to these aspects listed above: in all cases, the primary attributes of DEQs are agnostic to the particular choice of function ƒ_{θ}. That is, for different functional designs, single-variate, multi-variate, or even multi-resolution equilibrium systems, a unified and modular interface for implementing DEQs can be built. However, implementing a DEQ is still challenging, as all the components shown above, and further extensions, require skilled design and verification. Differences in implementation can significantly impact downstream performance, stability, and efficiency, as discussed below.

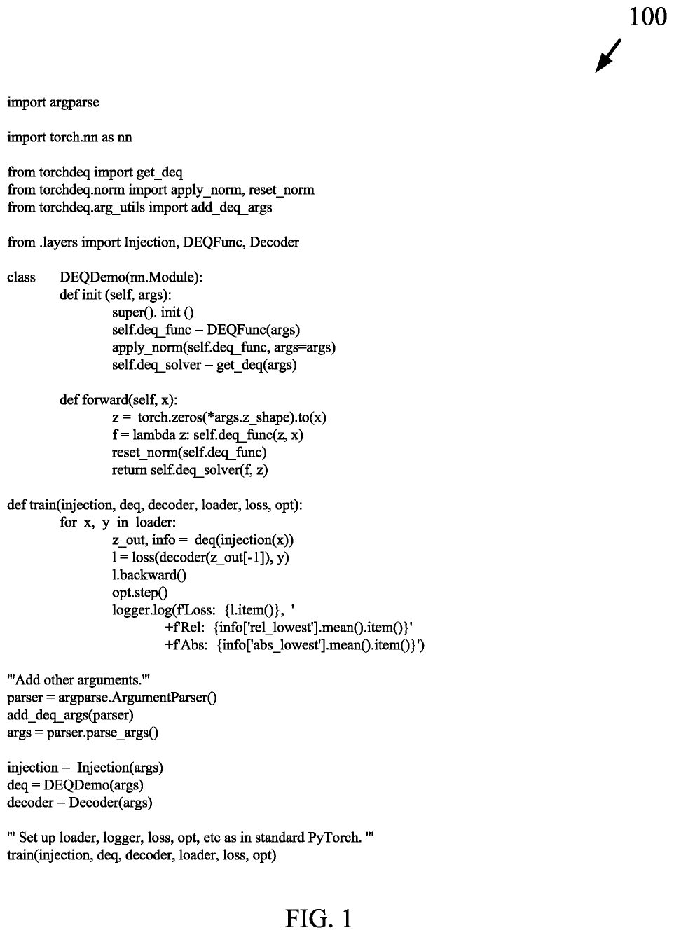

FIG. 1 illustrates sample code for making and using disclosed embodiments including using a TorchDEQ library and methods for building and training DEQs.

The operation of get_deq may return a DEQ solver as a Pytorch Module. Users need to pass a functor f that defines the function call to ƒ_{θ} with the input injection x and the initialization z⁰ for fixed point solvers. Fixed point reuse may be done through user-chosen previous fixed points. For a multi-variate equilibrium system of different tensor shapes, like z*=[h*, c*], one only needs to rewrite the functor with a trivial adjustment; TorchDEQ can accomplish the remaining adjustment for gradients and solvers.

$$f = lambda h , c : self . deq\_func ( ( h , c ) , x )$$

The operation of apply_norm and reset_norm may automatically apply normalizations to weight tensors in the equilibrium module ƒ_{θ} and may recompute the values for each weight tensor before the next training step. More detail is disclosed in Section 2.5.

The operation of add_deq_args may provide a decorator for the commonly used Python argument parser. Users of disclosed embodiments may simply call add_deq_args (parser) and customize a DEQs' behavior through the command line. This design has been adopted by community-trusted libraries like fairseq and timm.

$$python train . py -- ift -- f\_solver anderson -- b\_solver broyden$$

For example, the above command launches the training using implicit differentiation as the backward, Anderson Acceleration as the forward solver, and Broyden's method as the backward solver.

TorchDEQ's compact and modular interfaces may enable users to focus on how to abstract, formulate, and define their demands as an equilibrium model ƒ_{θ} and devise its interaction with other explicit layers like injection and decoder. The modular design of TorchDEQ creates an “abstraction” for DEQs and reduces the cost of learning, implementing, and tuning DEQs to a minimum. In the following sections, we introduce the features of TorchDEQ and their control command.

### 2.3 Backward Pass

TorchDEQ may internally create computational graphs for solvers and gradients. Users may receive a group of tensors registered with gradients. Users may work on the outputs of the implicit model just as they would explicit layers and tensors. However, when computing gradients, TorchDEQ may transparently compute the backward pass using specialized methods. TorchDEQ may support two types of backward passes, namely implicit differentiation (“IFT”) and phantom gradients (“PG”). In practice, both types and/or their combination may suffice to provide empirically appealing results within a reasonable time frame.

Implicit Differentiation (i.e., IFT). Implicit differentiation is the standard approach to differentiate through fixed points. As illustrated in Eq. (3), implicit gradients can be solved from another linear fixed-point system in the backward pass. Users may declare IFT through -ift, set a backward solver using -b_solver broyden, and set up solver configurations like maximum solver steps -b_thres 30 and stopping criteria -b_eps 0.001, for example.

Phantom Gradient (i.e., PG). Phantom Gradient is a structured approximation of IFT that keeps the descent direction,

$$\frac{\partial L}{\partial θ} \approx = \frac{\partial L}{\partial {z}^{*}} A . \qquad ( 4 )$$

$$where 〈 , \frac{\partial L}{\partial θ} 〉 > 0$$

preserves a valid gradient update, and A is an approximate Jacobian defined below.

Phantom gradients may be applied to computational graphs of various solvers, which is similar to IFT for differentiating fixed points. The previous views consider IFT as an exact gradient and PG as an inexact gradient. However, there may be numerical errors in solving the forward and IFT. Consequently, distinguishing from exact or inexact gradients may not be necessary and they can be referred to backward passes together instead.

An instantiation of PG used in different implicit models includes unrolling the equilibrium module ƒ_{θ} over the solved (approximate) fixed points z^{p} with a damping factor τ,

$${z}^{p + 1} = τ {f}_{θ} ( {z}^{p} ) + ( 1 - τ ) {z}^{p} , \qquad ( 5 )$$

which defines the following A matrix,

$$A = τ {\sum }_{j = p}^{K - 1} {\prod }_{s = k + 1}^{K - 1} ( τ \frac{\partial y}{\partial x} {\vert}_{{z}^{s}} + ( 1 - τ ) I ) \frac{\partial {f}_{θ}}{\partial θ} {\vert}_{{z}^{k}} . \qquad ( 6 )$$

Users may call PG, for example, by -grad 5-tau 0.6 combined with Broyden's method as the forward solver.

In disclosed embodiments separate support for backpropagation through time (“BPTT”) and its truncated version is not defined because they can be expressed as special cases of PG given τ=1.0 and removing the forward solver, i.e., the solver and gradient are solely defined by an unrolled process of ƒ_{θ}. Using a command of -f_thres 0-grad 12-tau 1.0 defines a computational graph of BPTT-12.

Disclosed embodiments may include an interface mem_gc to reduce the memory usage of any unrolled computational graph. Users may trade training time by 1.5× to obtain a much lower constant memory overhead via gradient checkpointing.

### 2.4 Solvers

Prior art DEQ projects usually wrote their own fixed-point solvers. These task-dependent solvers can be inefficient or even sometimes unreliable when applied to different domains. Addressing this problem, disclosed embodiments implement, verify, and polish solver implementations for TorchDEQ. The batching and memory access for multi-variate systems may be optimized. In disclosed embodiments solvers may be reliable in various tasks, robust across different settings, and agnostic to the scale of fixed-point equations and their tensor shapes. Accordingly, disclosed embodiments may lead to significant efficiency improvements over multi-variate and multi-scale equilibrium systems.

In TorchDEQ, the following solvers may be supported. To call these solvers, users may type -f_solver or -b_solver with solver names in the command line and their maximum iterations -f_thres 20 and stopping criteria -f_eps 1e−2. In addition, keyword arguments may be passed to the DEQ class to tune a solver. An example of customizing Anderson Acceleration, for instance, could be accomplished as

$$z\_out , info = self . deq\_solver ( f , z , solver\_kwargs = \{ {}^{′} {tau}^{′} : 0.8 , {}^{′} {m}^{′} : 6 \} ) .$$

Naïve Solver. Fixed point iteration is the classic solver for solving fixed points z*, described by the following numerical scheme,

$${z}^{k + 1} = {f}_{θ} ( {z}^{k} ) . \qquad ( 7 )$$

Its convergence can be guaranteed by a bounded Jacobian spectral radius of ƒ_{θ}. Users may type -f_solver naive_solver to call fixed-point iterations.

Anderson Solver. Anderson Acceleration, or Anderson mixing (i.e., Type-I Anderson Acceleration), is an acceleration technique for fixed-point iterations using the linear combination of past m+1 fix points estimations. Its update employs this numerical scheme,

$${z}^{k + 1} = τ {\sum }_{i}^{m} {α}_{i}^{k} {f}_{θ} ( {z}^{k - m + 1} ) + ( 1 - τ ) {α}_{i}^{k} {z}^{k - m + i} , \qquad ( 8 )$$

where τ is a dampening factor with a default value of 1.0. Given g_{θ}(z)=ƒ_{θ}(z)−z, G^{k}=[g_{θ}(z^{k-m}), . . . , g_{θ}(z^{k})], α^{k}=[α₀^{k}, . . . , αₘ^{k}] is solved from

$$arg {min}_{α} {‖ {G}^{k} α ‖}_{2} ) \qquad ( 9 )$$

$${1}^{T} α = 1$$

Users may call Anderson Acceleration via -f_solver anderson and tune it referring to the sample above.

Broyden Solver. Broyden's method is a quasi-Newton solver for fixed-point equations. By maintaining a buffer, Broyden's method approximates the Jacobian inverse in Newton's method through low-rank updates,

$${z}^{k + 1} = {z}^{k} - α \cdot {B}^{k} {g}_{θ} ( {z}^{k} ) , \qquad ( 10 )$$

where B^{k} is the approximation of Jacobian inverse J_{gθ} using Δz^{k}=z^{k}−z^{k-1} and Δg^{k}=g_{θ}(z^{k})−g_{θ}(z^{k-1}),

$${B}^{k} = {B}^{k - 1} + \frac{Δ {z}^{k} - {B}^{k - 1} Δ {g}^{k}}{Δ {z}^{{k}^{T}} {B}^{k - 1} Δ {g}^{k}} Δ {z}^{{k}^{T}} {B}^{k - 1} . \qquad ( 11 )$$

Equation (10) can be written into a matrix-vector product that further avoids storing B^{k} in memory,

$${z}^{k + 1} = {z}^{k} - α \cdot ( {B}^{0} + {U}^{k} {V}^{{k}^{T}} ) {g}_{θ} ( {z}^{k} ) , \qquad ( 12 )$$

where U^{k} and V^{k} represent m past estimations for the low-rank approximation via the Sherman-Morrison formula. Users can call the Broyden's method through -f_solver broyden or its limited-memory version, for example, by setting solver_kwargs={‘l_thres’:m}.

### 2.5 Normalization

Normalization techniques are vital to modern deep equilibrium models. Unlike popular normalization methods applied to representations, DEQs additionally rely on normalization for weight tensors, e.g., Weight Normalization, Spectral Normalization. In disclosed embodiments, DEQ versions of normalization techniques are supported in TorchDEQ.

Normalization significantly smooths the fixed-point landscape of z given the input data x and makes the fixed points easier to solve in practice. This effect appears to be underestimated in prior literature.

For a weight matrix W∈R^{m×n}, Weight Normalization (“WN”) parametrizes the weight into

$${W}_{i :} = {W}_{i :} \frac{{g}_{i}}{‖ {W}_{i :} ‖} , \qquad ( 13 )$$

where ∥⋅∥ stands for vector L₂ norm, g is a learnable scaling factor, while Spectral Normalization (“SN”) states

$$W = \frac{W}{{‖ W ‖}_{2}} = W \frac{1}{{‖ W ‖}_{2}} , \qquad ( 14 )$$

where ∥⋅∥₂ is the spectral norm, which may be computed by power iterations.

In disclosed embodiments, TorchDEQ supports both of the above normalization methods via the formalism,

$$W = W ∘ f = W ∘ \frac{g}{N ( W )} , \qquad ( 15 )$$

where ∘ is row-wise multiplication, and N stands for computing the relevant “norm” for the weight matrix. Following WN, a learnable scaling g may be added to DEQ SN, which may enable SN to match WN's performance and generalization on DEQ-Flow.

Inspired by gradient clipping, disclosed embodiments introduce an operation that significantly stabilizes the training of implicit graph neural networks on node classification, i.e., by clipping the rescaling factor to a threshold t,

$$W = W ∘ min ( t , f ) = W ∘ min ( t , \frac{g}{N ( W )} ) . \qquad ( 16 )$$

This may be enabled in TorchDEQ by -norm_clip with -norm_clip_value t.

Classic implementations for WN and SN reset the weight in every forward call. However, this is a visible waste for DEQ because the equilibrium module ƒ_{θ} will be called many times until convergence. Then the same weight parameterizations are applied by the number of ƒ_{θ} function calls. Plus, decorating normalization has to be manually coded for each module using a prior art PyTorch implementation.

Instead, in disclosed embodiments of TorchDEQ, unified interfaces are provided for automatically decorating the entire equilibrium module ƒ_{θ} through apply_norm (with the keyword argument filter_out to skip some modules) and reset_norm for resetting without wasting compute. After training, the normalization decorations may be removed by remove_norm, as they do not change the model but ease its training.

Users of TorchDEQ may specify -norm type weight norm for WN, -norm type spectral norm for SN, and additionally -norm no scale for removing the learnable scaling g.

### 2.6 Regularization

A conceptual change is ongoing in most modern interpretations of DEQ learning. Instead of considering DEQ models just as learning a performant (implicit) fixed point mapping x→z*, they are thought of as learning a smooth and flat equilibrium landscape x→B(z) that contains a unique and performant fixed point z*.

The regularity of the equilibrium module ƒ_{θ} guarantees a fast convergence to fixed points z* despite using a simple solver. The correspondence between the equilibrium landscape B(z) and loss landscape indicates a strong correlation between fixed point errors ∥ƒ_{θ}(z)−z∥ and the losses L(y(z)). The path independence, i.e., converging to the steady state regardless of initialization, may allow exploitation of test time computing better. Thus, prior art approaches consider DEQs as a dynamic implicit neural network that can obtain strong results in the early equilibrium-solving process and gradually improve its prediction as approaching fixed points z*. Disclosed embodiments of TorchDEQ support techniques promoting these DEQ properties and the regularity of equilibrium landscapes.

Jacobian Regularization (“JR”). Jacobian Regularization penalizes the upper bound of Jacobian spectral radius ρ(J_{f}_{_{θ}}) according to:

$$ρ ( {J}_{{f}_{θ}} ) \leq {‖ {J}_{{f}_{θ}} ‖}_{F} = \sqrt{tr ( {J}_{{f}_{θ}}^{T} {J}_{{f}_{θ}} )} . \qquad ( 17 )$$

Computationally, this is accomplished by adding a loss term using the stochastic Hutchinson trace estimator, e.g., sampling ϵ from a standard Gaussian,

$$tr ( {J}_{{f}_{θ}}^{T} {J}_{{f}_{θ}} ) \approx {\sum }_{ϵ ∼ p ( ϵ )} {‖ {J}_{{f}_{θ}} ϵ ‖}_{2}^{2} . \qquad ( 18 )$$

Disclosed embodiments of TorchDEQ may provide an interface jac_reg that takes ƒ_{θ}(z) and z to compute the JR loss.

Fixed-Point Correction (“FC”). Fixed-point correction helps learn a smooth equilibrium landscape by regularizing intermediate states from the fixed points solving process. Given a sequence \tilde{Z}=[z^{k}^{₁}, . . . , z^{k}^{ₙ}] that converges to z*, correction can either decode the states and supervise the predictions

$$min {\sum }_{i}^{n} {γ}^{n - i} L ( y , y ( {z}^{{k}_{i}} ) ) , γ \leq 1 , \qquad ( 19 )$$

or apply Jacobian regularization to this sequence,

$$min L ( y , y ( {z}^{*} ) ) + γ {\sum }_{i}^{n} {\sum }_{ϵ ∼ p ( ϵ )} {‖ {J}_{{f}_{θ}} ( {z}^{{k}_{i}} ) ϵ ‖}_{2}^{2} . \qquad ( 20 )$$

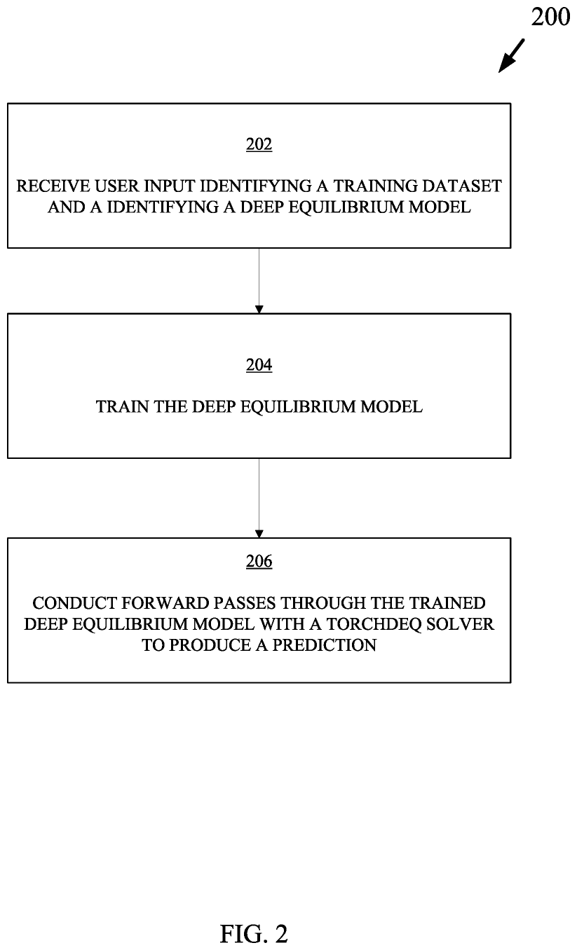

FIG. 2 illustrates an example method 200 for training and using a DEQ in accordance with disclosed embodiments. In some disclosed embodiments the method 200 is performed by TorchDEQ. At operation 202, the method receives input data from a user. The input data may identify a training dataset and identify a deep equilibrium model. For a first example, the training dataset may be identified by the user selecting an item from a displayed menu. The training dataset may already be preloaded into TorchDEQ, or it may be loaded in TorchDEQ in response to the user input. Optionally, a user input may also identify an injection module and/or a decoder module. In disclosed embodiments, TorchDEQ allows user to customize forward and/or backward solvers from the TorchDEQ library. For example, the input data from a user may include parameters for modifying one or more forward and/or backward solvers.

At operation 204, TorchDEQ trains the deep equilibrium model. To conduct forward and backward passes through non-DEQ modules, TorchDEQ may use default PyTorch functionality. To conduct forward and backward passes through a DEQ module, TorchDEQ may use forward and/or backward DEQ solvers from the TorchDEQ library. The forward and/or backward solvers used by TorchDEQ may be forward and/or backward solvers customized by modifying parameters in accordance with parameters provided by a user in the input data from the user. During the training of a deep equilibrium model, TorchDEQ may perform one or more of automatic normalization of weight tensors, Jacobian Regularization, and Fixed-Point Correction.

At operation 206, TorchDEQ may conduct forward passes through a trained deep equilibrium model with a DEQ solver to produce a prediction. For example, trained deep equilibrium model may perform predictions on test data.

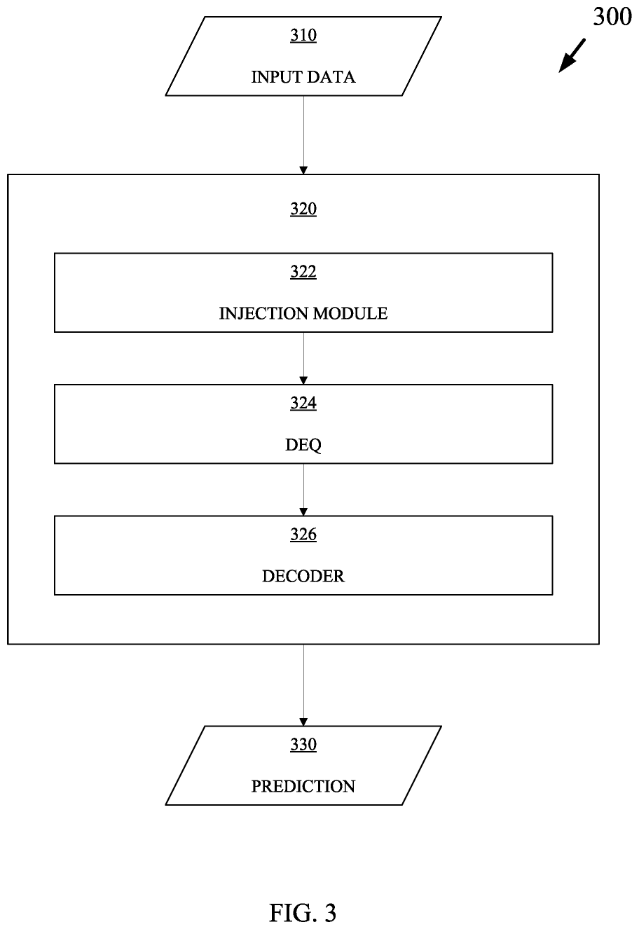

FIG. 3 illustrates a block diagram of a system 300 in accordance with disclosed embodiments. For example, system 300 may be an implementation of TorchDEQ. Input data 310 may be input into a model 320. The input data 310 may be, for example, the input data discussed above with respect to FIG. 2. Model 320 includes an optional injection module 322, a DEQ 324, and an optional decoder 326. The model 320 outputs a prediction 330.

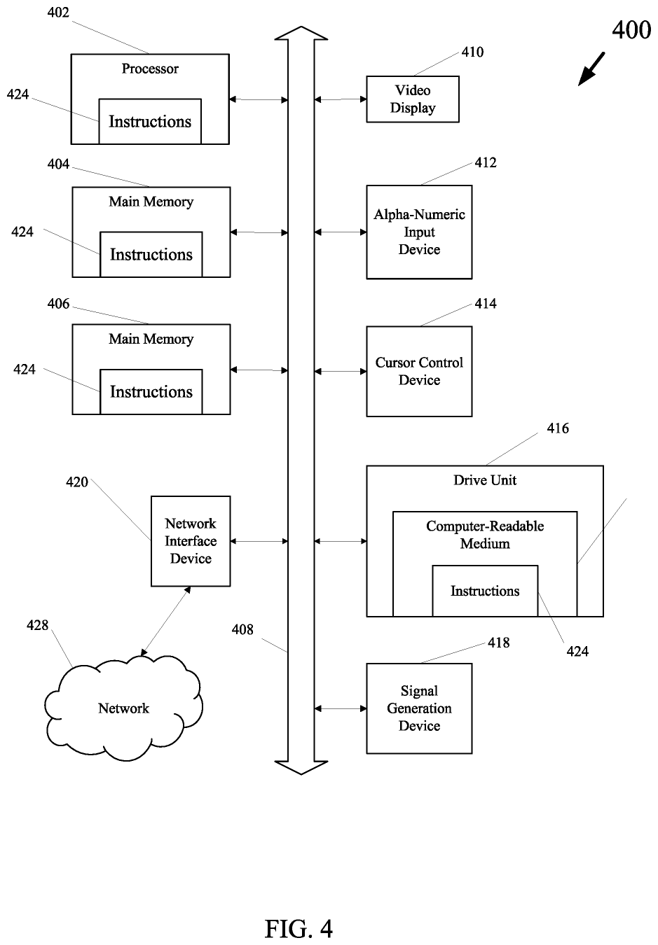

FIG. 4 shows a block diagram of an example embodiment of a general computer system 400. The computer system 400 can include a set of instructions that can be executed to cause the computer system 400 to perform any one or more of the methods or computer-based functions disclosed herein. For example, the computer system 400 may include executable instructions to perform functions of TorchDEQ. The computer system 400 may be connected to other computer systems or peripheral devices via a network. Additionally, the computer system 400 may include or be included within other computing devices.

As illustrated in FIG. 4, the computer system 400 may include one or more processors 402. The one or more processors 402 may include, for example, one or more central processing units (CPUs), one or more graphics processing units (GPUs), or both. The computer system 400 may include a main memory 404 and a static memory 406 that can communicate with each other via a bus 408. As shown, the computer system 400 may further include a video display unit 410, such as a liquid crystal display (LCD), a projection television display, a flat panel display, a plasma display, or a solid-state display. Additionally, the computer system 400 may include an input device 412, such as a remote-control device having a wireless keypad, a keyboard, a microphone coupled to a speech recognition engine, a camera such as a video camera or still camera, or a cursor control device 414, such as a mouse device. The computer system 400 may also include a disk drive unit 416, a signal generation device 418, such as a speaker, and a network interface device 420. The network interface 420 may enable the computer system 400 to communicate with other systems via a network 428. For example, the network interface 420 may enable the machine learning system 120 to communicate with a database server (not show) or a controller in manufacturing system (not shown).

In some embodiments, as depicted in FIG. 4, the disk drive unit 416 may include one or more computer-readable media 422 in which one or more sets of instructions 424, e.g., software, may be embedded. For example, the instructions 424 may embody one or more of the methods or functionalities, such as the methods or functionalities disclosed herein. In a particular embodiment, the instructions 424 may reside completely, or at least partially, within the main memory 404, the static memory 406, and/or within the processor 402 during execution by the computer system 400. The main memory 404 and the processor 402 also may include computer-readable media.

In some embodiments, dedicated hardware implementations, such as application specific integrated circuits, programmable logic arrays and other hardware devices, can be constructed to implement one or more of the methods or functionalities described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations, or combinations thereof.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or functionalities disclosed herein.

In some embodiments, some or all of the computer-readable media will be non-transitory media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A method comprising:
receiving user input identifying a deep equilibrium model and identifying a training dataset; and
training the deep equilibrium model on the training dataset, wherein the training includes performing a normalization method according to:
$$W = W ∘ min ( t , f ) = W ∘ min ( t , \frac{g}{N ( W )} )$$
where ƒ is the deep equilibrium model, W is a weight matrix, g is a learnable scaling factor, ∘ is a row-wise multiplication, t is a threshold for clipping the scaling factor g, and Nis a computation of a norm for the weight matrix W.

2. The method according to claim 1, wherein the user input identifies an injection module.

3. The method according to claim 1, wherein the user input identifies a decoder module.

4. The method according to claim 1, wherein the training includes performing forward and backward solvers to conduct forward and backward passes through the deep equilibrium model.

5. The method according to claim 4, wherein one or more of the forward and backward
solvers are modified by parameters included in the user input.

6. The method according to claim 1, wherein the training includes performing one or more of the following:
automatic normalization of weight tensors;
Jacobian regularization; and
fixed point correction.

7. The method according to claim 4, wherein the training includes performing one or more of the following:
automatic normalization of weight tensors;
Jacobian regularization; and
fixed point correction.

8. A method comprising:
receiving user input identifying a deep equilibrium model and identifying a training dataset; and
training the deep equilibrium model on the training dataset, wherein the training includes performing forward and backward solvers to conduct forward and backward passes through the deep equilibrium model, and wherein the forward and backward solvers are identified in the user input.

9. The method of claim 8, wherein one or more of the forward and backward solvers are modified by parameters included in the user input.

10. The method according to claim 8, wherein the training includes performing one or more of the following:
automatic normalization of weight tensors;
Jacobian regularization; and
fixed point correction.

11. The method according to claim 8, wherein the user input identifies an injection module.

12. The method according to claim 8, wherein the user input identifies a decoder module.

13. The method according to claim 8, wherein the training includes performing a normalization method according to:
$$W = W ∘ min ( t , f ) = W ∘ min ( t , \frac{g}{N ( W )} ) — ,$$
where ƒ is the deep equilibrium model, W is a weight matrix, g is a learnable scaling factor, ∘ is a row-wise multiplication, t is a threshold for clipping the scaling factor g, and Nis a computation of a norm for the weight matrix W.

14. The method according to claim 10, wherein the training includes performing a normalization method according to:
$$W = W ∘ min ( t , f ) = W ∘ min ( t , \frac{g}{N ( W )} )$$
where ƒ is the deep equilibrium model, W is a weight matrix, g is a learnable scaling factor, ∘ is a row-wise multiplication, t is a threshold for clipping the scaling factor g, and Nis a computation of a norm for the weight matrix W.

15. A system comprising:
one or more processors; and
non-transitory memory including processor-executable instructions that, when executed by the one or more processors, causes the system to perform operations including:
receiving user input identifying a deep equilibrium model and identifying a training dataset; and
training the deep equilibrium model on the training dataset, wherein the training includes:
performing forward and backward solvers to conduct forward and backward passes through the deep equilibrium model, wherein the forward and backward solvers are identified in the user input; and
performing one or more of the following:
automatic normalization of weight tensors;
Jacobian regularization; and
fixed point correction.

16. The system according to claim 15, wherein the user input identifies an injection module.

17. The system according to claim 15, wherein the user input identifies a decoder module.

18. The system according to claim 15, wherein one or more of the forward and backward solvers are modified by parameters included in the user input.

19. The system according to claim 15, wherein
the training includes performing a normalization method according to:
$$W = W ∘ min ( t , f ) = W ∘ min ( t , \frac{g}{N ( W )} ) — ,$$
where ƒ is the deep equilibrium model, W is a weight matrix, g is a learnable scaling factor, ∘ is a row-wise multiplication, t is a threshold for clipping the scaling factor g, and Nis a computation of a norm for the weight matrix W.

20. The system according to claim 18, wherein
the training includes performing a normalization method according to:
$$W = W ∘ min ( t , f ) = W ∘ min ( t , \frac{g}{N ( W )} ) — ,$$
where ƒ is the deep equilibrium model, W is a weight matrix, g is a learnable scaling factor, ∘ is a row-wise multiplication, t is a threshold for clipping the scaling factor g, and Nis a computation of a norm for the weight matrix W.
